(19) United States
(12) Patent Application Publication
(10) Pub. No.: US 2008/0228530 A1
(43) Pub. Date: Sep. 18, 2008

(54) METHOD AND DATA PROCESSING SYSTEM TO ASSIST A MEDICAL DIAGNOSIS

(76) Inventors: Ernst Bartsch, Nurnberg (DE); Peter Huber, Windsbach (DE); Bastian Rackow, Herzogenaurach (DE); Michael Rusitska, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 12/047,395

(22) Filed: Mar. 13, 2008

(30) Foreign Application Priority Data
Mar. 13, 2007 (DE) 10 2007 012 048.8

(51) Int. Cl. G06Q 50/00

(52) U.S. Cl. 705/3; 705/2

(57) ABSTRACT

In order to assist medical personnel in the generation of a medical diagnosis, context-related criteria are automatically determined from available case-related primary information, and using these context-related criteria context-related secondary information is automatically filtered out from a secondary data source and is displayed in an information portal on a display element for further processing by medical personnel. Case-related secondary information that support the personnel in the generation of an applicable diagnosis of the current case thus are automatically provided to the medical personnel via this measure.

### BACKGROUND OF THE INVENTION

1. Field of the Invention

The present invention concerns a method for assisting in the making of a medical diagnosis with regard to a medical case as well as a data processing system for implementation of the method.

2. Description of the Prior Art

In the making of a medical diagnosis (finding) by a medical specialist (physician) with regard to a particular medical case, the medical specialist accesses a number of items of information. Such information is in particular examination data of the appertaining patient, x-ray images, etc. Using this patient-specific information the physician generates a patient-specific diagnosis. The generation of the medical diagnosis is complex since a suitable analysis and evaluation of the available information is necessary, for which a considerable expertise is required. In addition to the knowledge of the medical contexts this expertise also concerns the capability to correctly assess the present information. This is particularly the case for image data acquired with modern imaging methods.

In order to be able to correctly assess the present patient data for the generation of a medical diagnosis, the medical specialist ideally accesses secondary information such as, for example, publications in technical journals, reports about comparable cases etc. in addition to the patient-specific information. It is difficult and time-consuming to determine the relevant secondary information from the multiple of possible items of secondary information.

### SUMMARY OF THE INVENTION

An object of the present invention is to give the medical personnel assistance with which the generation of a medical diagnosis for a specific case is simplified.

The object is achieved according to the invention by a method to assist in the generation of a diagnosis regarding a medical case wherein context-related criteria are automatically determined from electronic, case-related primary information. Electronically-available context-related secondary information is subsequently automatically filtered out from a secondary data source using the context-related criteria. This context-related secondary information is finally displayed in an information portal on a display element.

As used herein, “primary information” encompasses all information that is available for the current case in the manner of a local knowledge base. Such primary information that includes patient-specific (thus case-related) data for the current medical case regarding which a diagnosis should be created. Moreover, such information also includes information that is currently available in the organization unit (for example the clinic, the physician's practice or another unit) with regard to the medical case to be assessed.

As used herein, “context-related” encompasses case-related criteria that are characteristic for the medical case to be examined. These context-related criteria are effectively used as search criteria in order to filter out the context-related secondary information from an available electronic secondary data source. Context-related secondary information accordingly includes such secondary information that is relevant for the assessment of the current medical case. For example, this context-related secondary information is such information that is concerned with the same clinical picture, with the same examination type or the same examination apparatuses. Secondary information is generally such information that is not primary information (thus not directly case-related information) that is available to the organization structure (clinic, practice).

The context-related secondary information (therewith secondary information relevant to the medical personnel) filtered out from the secondary data source is displayed on a display element in what is known as an information portal. In the simplest case an information portal is an information window or a menu window presented on the display element.

The particular advantage of this method is to be seen in that context-related secondary information is determined automatically without a manual input by the medical personnel and is handed to the medical personnel for the generation of the diagnosis (finding). The medical personnel therefore do not need to search out such secondary information themselves. Rather, this is directly and immediately given to them by the system.

In preferred embodiments the primary information that forms the basis for the determination of the context-related criteria (and therewith the basis for the context-related secondary information) includes data from an electronic patient record that are relevant to the current case. In addition to personal information of the patient (such as age, gender, size, weight), patient-specific examination results as well as prior diagnoses, etc. are also included in such an electronic patient record.

Moreover, in a preferred embodiment the primary information additionally includes image information supplementary to case-related diagnosis images. Such supplementary image information is, for example, acquisition parameters for a respective diagnosis image such as, for example, exposure type, apparatus type, type of the image preparation, setting parameters of the (in particular radiological) diagnosis apparatus etc. Relevant information which was important to the medical personnel in the acquisition of the diagnosis images can often already be extracted from this supplementary image information. This primary information represents an optimally broad (and therewith precise) case-related knowledge base. Such criteria that exhibit a high probability that they are particularly relevant to the current case are automatically determined by the system using all of these items of information.

Moreover, the primary information also can include data regarding the current user. The possibility to select the criteria corresponding to the expertise to be assumed of different users. If the logged-in user is a specialist physician, those criteria are established that also filter out complex technical information from the secondary information. By contrast, if only medical support personnel are logged in, correspondingly tailored criteria are compiled. The context-related criteria are therefore generally determined specific to the user.

The determination of the context-related criteria hereby advantageously ensues on the basis of probability considerations, thus on the consideration of which available primary information is particularly relevant with which probability for the current case. In particular the context-related criteria are selected with using Bayesian statistics. The selection of the context-related criteria is therefore at least rudimentarily based on a probabilistic expert system and effectively forms an artificial intelligence within the system, this artificial intelligence being used for the selection of the context-related criteria. The tools of Bayesian statistics are used in different fields and are generally known. For example, Bayesian statistics is used in e-mail spam filters in order to fashion a self-learning system to filter out unwanted e-mail.

In particular search terms (thus words) are drawn upon as context-related criteria using which the context-related secondary information is sought in the secondary data source. A search query such as can be input by the respective user in typical search engines, for example, is effectively automatically recreated with the search terms. The context-related search terms can therefore be inserted without problems into corresponding input masks of existing search engines via this measure in order to be able to determine the corresponding secondary information.

The determination of the context-related search terms is hereby advantageously assisted by a routine provided by a language module in which search terms are determined based on acceptable terms from the primary information, using which the context-related search terms are then determined. In particular the semantics of the available primary information are analyzed and evaluated here. For example, the language module serves to translate frequently-used abbreviations into generally accepted terms in order to be able to generate suitable search terms. This is particularly helpful when specific abbreviations or terms have developed within the organization structure but that are not known or are barely known outside of this organization structure and therefore would be unsuitable as search terms in external databases.

The determined context-related secondary information is automatically expediently prioritized. This prioritization hereby likewise advantageously ensues with the aid of Bayesian statistics. The most important secondary information is displayed to the user first via this automatic prioritization.

Control commands that serve to execute auxiliary programs to determine the secondary information are preferably automatically generated from the context-related criteria. Such auxiliary programs are, for example, executable programs such as Internet browsers that are necessary or helpful for searching through the secondary data source. The possibility hereby exists to generate data source-specific control commands using different secondary data sources.

According to a convenient embodiment the automatically determined, context-related criteria (in particular search terms) can be edited by the user. A search can hereby be manually refined. The automatically determined search terms are hereby expediently displayed in a corresponding input field, such that the user recognizes on what basis (context-related criteria) the currently displayed context-related secondary information was determined.

Different types of secondary data sources are preferably used in order to obtain an optimally comprehensive and broad base of secondary information. These are advantageously both internal, access-protected data sources and public data sources. Access-protected internal data sources as used herein means data sources that are available to the respective organization unit that, for example, are connected with one another via the internal computer network. The corresponding data are, for example, stored on a server or also on a local computer. Access to these data from outside of the organization unit is not possible. In contrast to the public data sources, no public access is thus present. By contrast, public data sources as used herein means such data sources that are available to anyone, possibly after a preceding authentication. Such data sources can also be maintained by a service provider and be databases with medical information that are made available for a usage fee.

In an appropriate embodiment one or more of the following data sources are selected as secondary data sources:
A data source comprising diagnosis data regarding different medical cases. This is in particular an internal database in which all information of the respective organization unit (clinic) with regard to the medically relevant data are advantageously comprised. Such systems and databases are, for example, typically of the type known as an RIS system (radiology information system), a PACS system (picture archiving and communication system) or an HIS (hospital information system). Instead of an internal data source, diagnosis data regarding different medical cases can be provided at an external data source. Medical cases comparable to the current case to be examined are therefore determined from this data source using the context-related criteria.
A particular public data source comprising medical reference data. Such reference data can exist both as text data and image data. “Reference data” encompasses such data that reflect typical cases as are presented, for example, textbooks, publications, etc. in order to illustrate typical features, manifestations, etc. of a specific clinical situation. In particular typical reference images are stored in this reference data source. Such an image reference database is of particular advantage in medical diagnostics in radiology making use of medical diagnosis images since the evaluation of such radiology images (generated, for example, with the aid of computer tomography) are to some extent difficult to evaluate. An important assistance in order to be able to generate a correct diagnosis is therefore given to the medical personnel via comparison with reference images.
An Internet-based data source (in particular the Internet itself) which is searched through with a search engine. The Internet represents a very large pool of constantly changing (in particular updated) secondary information, such that the most current secondary information (for example new publications, new reports, etc.) can always hereby be determined. All information sources offered over there Internet are hereby available. In addition to the passing retrieval of provided content, the possibility also exists to actively retrieve information from forums and discussion groups. An automatic logging on to such forums or discussion groups preferably ensues with the aid of the automatically generated control commands. Overall the knowledge pool provided by the entire Internet is automatically tapped.
An intranet-based data source, thus data that are generally available within the organization structure. In larger organization units network-based knowledge structures can likewise form within the organization unit that are tapped via this data source (comparable to the Internet).
A local, user-related data source, in particular the respective directory of the currently logged-in user, for example. Personal data of the respective user are therewith also available.

Comprehensive secondary information is determined through the respective types of secondary data sources.

The data sources that should be used by the system to determine the secondary information can hereby be appropriately selected by the user. The user therefore independently makes a selection as to from where the secondary information should come.

In order to enable an optimally user-friendly and intuitive assistance of the medical personnel, the information portal within which the display of the secondary information ensues is integrated into a user interface of a superordinate medical operation software (in particular a radiology system or portal). Inasmuch a seamless and user-friendly software integration into an existing software program is achieved. The superordinate medical operation software is in particular a software with whose help the physician generates diagnoses. In addition to the access to patient-relevant data, such a software therefore also offers editable fields into which the physician can insert his current diagnosis and which is then automatically stored in the respective patient record, for example. Since the physician does not have to jump between different application programs, the physician is optimally assisted via the integration into such an operation software that is present anyway. The information assistance via the information portal therefore occurs integrated within the program with which the physician generates the diagnosis anyway.

A match list for the context-related secondary information is appropriately presented in a result window. A respective match can hereby be selected by the user from this match list. As soon as the respective match is selected, details regarding the selected match are displayed in an advantageously additional detail window. A simple navigation through the different matches is hereby enabled and the physician can quickly get an overview of the quality and the content of the secondary information. These windows (thus the result window and the detail window) are hereby integrated into the information portal so that a uniform operator guidance results. The software is in particular menu-driven and exhibits a browser-based design as it is known from Internet browsers.

Within the superordinate operation software the information portal is a specific menu point which, for example, is presented on the display in the manner of an index card. It is appropriately provided that the current context-related secondary information is retrieved and displayed upon calling the information portal (for example by clicking on the corresponding index card). The most current information is therefore presented upon invocation. Alternatively or in addition, the possibility naturally exists that preceding context-related secondary information are resorted to and these are displayed. This is particularly appropriate when the primary information has not changed since the last access. However, the automatic, current, context-related retrieval has particular advantages when the primary information has changed in comparison to a last access in order to present the most current and most relevant secondary information.

The above object also is furthermore achieved according to the invention by a data processing system with an executable program for implementation of the described method. Furthermore, the object is achieved by a computer program product formed by executable formed by a executable computer-readable medium such as a portable medium or a file transmitted online, encoded with programming instructions for implementing the method described above and all embodiments.

### BRIEF DESCRIPTION OF THE DRAWINGS

FIG. 1 is a first block schematically illustrating an embodiment of the method according to the present invention.

FIG. 2 is a block diagram schematically illustrating further details of the embodiment of the method illustrated in FIG. 1.

FIG. 3 is a simplified representation of a user interface suitable for use in accordance with the inventive method and data processing system.

### DESCRIPTION OF THE PREFERRED EMBODIMENTS

The method described as an example in the following represents a largely automated assistance of medical personnel in the generation of a medical diagnosis. A suitable executable software program which trains the data processing system 2 to execute the method is installed on a data processing system 2 for implementation of the method.

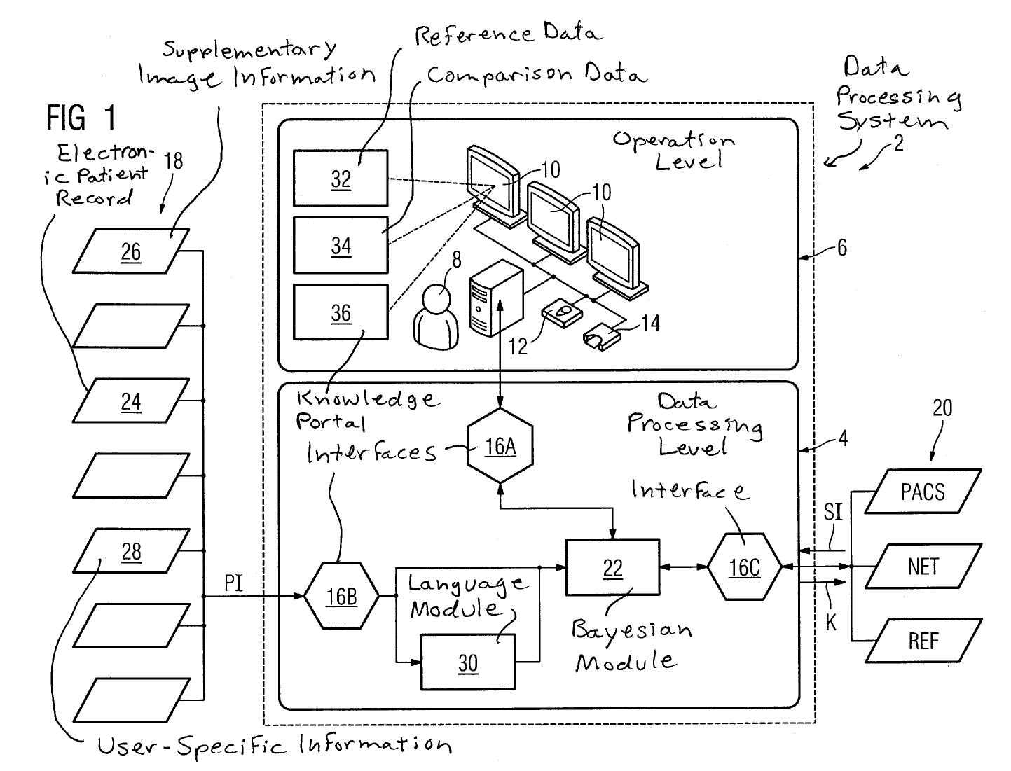

The data processing system 2 illustrated in simplified form by the dashed line in the depiction in FIG. 1 can be subdivided into a data processing level 4 and an operation level 6. The processes of data preparation, data processing etc. essentially occur within the data processing level 4. The operation level 6 essentially forms the interface to the respective user 8 and simultaneously serves for navigation of the user 8 within the functionalities provided by the program. The data processing on the data processing level 4 is enabled by a corresponding microprocessor and by suitable memory. In the exemplary embodiment a plurality of screens are provided in hardware as display elements 10 on the operation level 6. In addition to typical input devices such as keyboard, mouse, etc. (not shown in detail here), in the exemplary embodiment a reader 12 for biometric data and a card reader 14 are provided. Both readers 12, 14 serve, for example, for the identification of the user 8 in order to enable for said user an access (login) to the program. The communication between the data processing level 4 and the operation level 6 ensues via a first interface 16A. The data processing level 4 communicates with an internal knowledge pool 18 via a further interface 16B, via which internal knowledge pool 18 the primary information can be retrieved. The data processing level 4 furthermore communicates with secondary data sources 20 via a further interface 16C.

Upon execution of the method the data processing level 4 initially accesses the patient information PI of the knowledge pool 18. Context-related criteria K are determined from this patient information PI using a Bayesian module 22. Context-related secondary information SI is automatically determined from the secondary data sources 20 using these criteria K, the context-related secondary information SI being presented on a display element 10 on the operation level 6. This secondary information SI gives the user 8 supplementary information regarding the current medical case, such that the user 8 (in particular the physician who is charged with the generation of the medical diagnosis) can access case-related (and therewith context-related) secondary information and generate the diagnosis in a simple manner.

The fact that context-related secondary information SI relevant to the current case to be diagnosed is automatically determined from the secondary data sources 20 from the available patient information PI using the data processing level 4 and is provided without interaction/input of the user 8 being required is of particular advantage in this method. The entire routine representing this method is integrated in a user-friendly manner into a superordinate operation program on the operation level 6, which superordinate operation program the user 8 uses for the generation of the diagnosis.

A large breadth of information on the input side of the patient information PI is utilized in order to be able to automatically determine optimally significant and specific, case-related secondary information SI. Here all information accessible with regard to the current medical case can be retrieved in the knowledge pool 18. This is in particular an electronic patient record 24 that includes all data regarding the respective patient for whom the diagnosis should be currently generated. Furthermore, supplementary image information 26 from the patient information PI regarding diagnosis images of the appertaining patient is comprised. Such supplementary image information 26 is typically included in the DICOM header regarding individual digital radiological images. First information which was important to the treating physician in the acquisition of the diagnosis image can be learned using this supplementary image information 26. Indices are, for example, the effected settings at the diagnosis apparatus etc. Furthermore the patient information PI comprises user-specific information 28 that specifies who is currently logged on and who is working with the program.

Moreover, the patient information PI comprises further information, for example information about what should currently be diagnosed such as the anamnesis (history) of the diagnosis to be generated, which diagnosis images have already been acquired in advance, for example, etc. All of this information is either directly contained in the electronic patient record 24 or form knowledge effectively intrinsic to the system within the knowledge pool 18. The patient information PI is therefore available for retrieval within a computer network within an organization unit (such as, for example, a clinic). All of this patient information is patient-related (and therewith case-related) with regard to the current case to be diagnosed or, respectively, is information regarding the current diagnosing physician (user 8).

All of this patient information PI is evaluated and assessed by the Bayesian module 22. To form the basis of probability considerations it is hereby determined which of the available items of information are most relevant to the current case. The corresponding criteria K are then determined using this information estimated to be particularly relevant. These criteria K are in particular search terms. These are context-related insofar as they (by the operation of the Bayesian module 22) exhibit a high probability that they have a high relevance for the current case to be assessed. In the exemplary embodiment of FIG. 1 the Bayesian module 22 is assisted by a semantic or language module 30. The language module 30 evaluates the patient information PI with regard to language. It thus compares the terms included in the patient information PI with a stored dictionary, attempts to automatically determine a reasonable context using rules and outputs a prepared term to the Bayesian module 22 using this analysis of the terms comprised in the patient information under consideration of stored rules. For example, abbreviations are translated into complete words. Specific term sequences can also be precluded, expanded etc. using stored rules in order to obtain optimally good matches in a search in the secondary data sources 20.

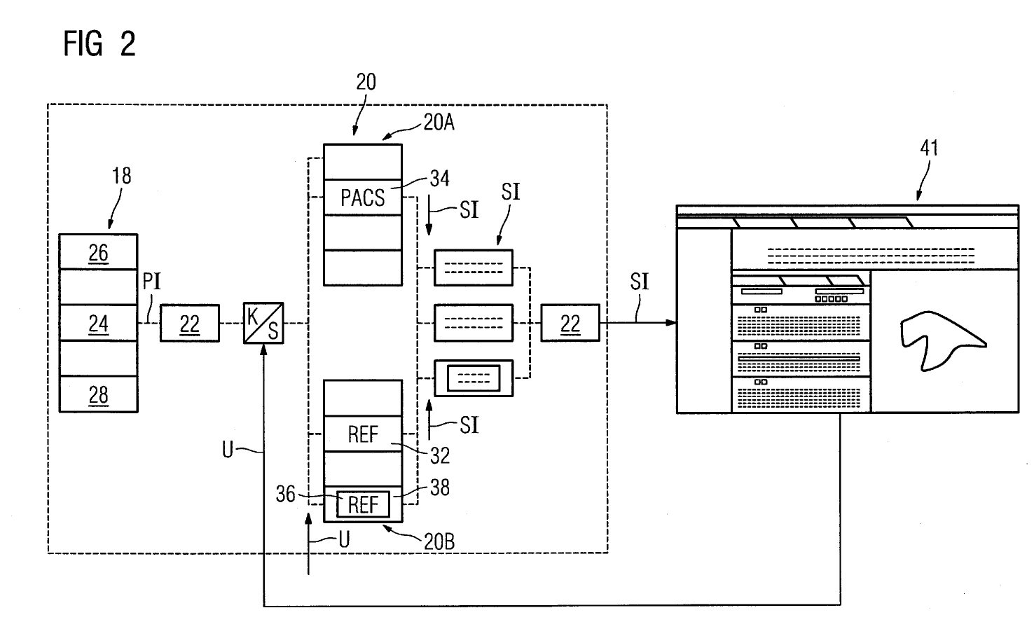

As can be seen from FIG. 2, the secondary data sources 20 can be subdivided into internal secondary data sources 20A and external secondary data sources 20B. Internal secondary data sources 20 are those data sources that exist within the organization unit (clinic, practice) and to which normally no access is possible from the outside. Contrary to this, external secondary data sources 20B are those data sources which can be openly accessed. For example, in particular the medical information system (which is subsequently designated as a PACS, Patient Archiving and Communication System) employed in the organization unit counts among the internal secondary data sources 20A. All information about the patients in the care of the organization unit is comprised in the framework of the PACS system. The PACS system therefore offers an extensive universal database for the respective organization unit (clinic) in which a plurality of individual items of information are stored with regard to the individual patients. This pertains to patient-specific data, diagnosis data, diagnosis images, etc. It is of particular importance that data regarding a plurality of different patients are comprised here. The PACS system therefore forms an internal data source regarding different medical cases. In addition, other information systems as they are typical today can also be drawn upon as internal data sources. In principle the possibility also exists to assess data that have been provided internally within an intranet. For example, specific groups have united within the intranet of a larger clinic for the exchange of information and form forums in which they exchange information about medical problems. A user-related directory to which only the respective logged-in user 8 has access forms a further example for an internal data source.

Examples for the external secondary data sources 20B are the Internet NET or external reference databases REF. Reference images that can be drawn upon as comparison images with regard to the current diagnosis images for the current finding (diagnosis) are advantageously provided in the external reference database REF. These reference images typically show image exposures for specific clinical pictures. Using a comparison with the reference images the physician can therefore establish in a simple manner whether the current diagnosis image indicates a corresponding clinical picture in the present case.

Discussion forums, current articles, user groups etc. are available via the Internet, such that the knowledge contained therein is also utilized as secondary information SI.

Overall different data types can therefore be identified that are offered to the user 8. These are reference data 32 (for example taken from the reference database REF), comparison data 34 (for example taken from the PACS system) and an entire knowledge portal 36 with secondary information SI (for example from the Internet NET). These different data types are exemplarily listed in FIG. 1 within the operation level 6.

In order to obtain the corresponding secondary information SI from the secondary data sources 20A, 20B, corresponding queries are sent to the secondary data sources 20A, 20B using the context-related criteria K. This occurs, for example, by the transfer of specific search terms using which the context-related secondary information SI is then obtained from the secondary data sources 20A, 20B. The context-related criteria K here are advantageously established and determined specific to the secondary data source in order to thus obtain an optimal match result for the respective case.

Insofar as it is required dependent on the respective secondary data source 20A, 20B, context-related control commands are also directly generated by the Bayesian module 22 in order to obtain the corresponding secondary information SI. Such control commands S or control routines start an Internet browser with search functionality as an auxiliary program 38 in, for example, the Internet-based database NET and input the predetermined search term within this browser.

The obtained secondary information SI is prepared within the data processing level 4 and is displayed in a suitable manner on the display element 10. A prioritization of the individual items of secondary information SI is provided with the aid of the or a further Bayesian module 22 (can be seen from FIG. 2), such that the most relevant matches are displayed first. A data source-specific prioritization thus ensues within the secondary information SI that was obtained from each data source 20A, 20B.

The individual data source-specific items of secondary information SI are displayed for the user 8 in data-specific groups.

The entire method for selection of relevant, context-related secondary information SI regarding the current case to be assessed runs entirely automatically without a case-related input by the user 8 being required. Rather, the sought-out secondary information SI is automatically displayed to the user 8.

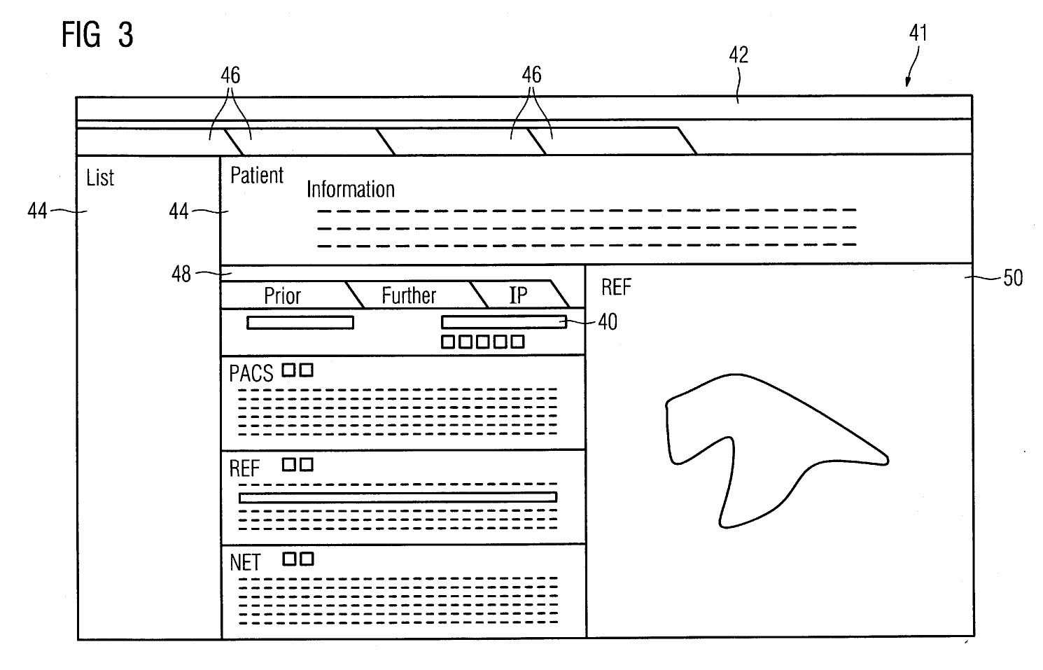

Nevertheless it is possible that the user 8 can actively intervene via special inputs. On the one hand the possibility exists for him to input a search term within a search field 40 (see in particular FIG. 3 in this regard) in order to refine the search. The search term or terms determined with the Bayesian module 22 are advantageously displayed in the search field 40. Furthermore, it is provided that the user 8 can select the respective secondary data sources 20 in which relevant secondary information should be sought. These interaction possibilities U are shown with the arrows in FIG. 2.

The operation level 6 and the operation for the user 8 are explained in detail using FIG. 3. FIG. 3 shows a typical graphical user interface of a medical data processing program (in particular in the field of radiology) which is typically used to assist in the generation of a diagnosis. For example, the operation ensues based on a browser with known menu bars 42, different windows 44 and registers 46 and sub-registers. In the shown exemplary embodiment, for example, a patient list “LIST” using which data regarding different patients can be called up is shown in the window 44 presented at the left. An item of patient-specific information (such as, for example, name, gender, age) as well as information about, for example, the current clinical picture, etc. appear in the window 44 “PATIENT” with regard to the respective selected patient. In a further result 48 information about already occurred examinations etc. (“PRIOR”) as well as about future measures (“FURTHER”), which information can be called up, is comprised in various registers “PRIOR”, “FURTHER”. The individual items of detail information in this regard can then be displayed in a detail window 50. An input window (not shown in detail) is additionally typically provided in which the physician inputs his or her diagnosis, which is then immediately stored in the system.

An information platform IP via which the method described in the preceding with regard to FIG. 1 and 2 can be started and executed by the user 8 is henceforth integrated into this typical medical operation software. In the example of FIG. 3 the index card “IP” has already been invoked, such that the user interface for this information portal IP is recognizable in the result 48. The search field 40 in which the criterion or criteria K (search term) determined by the Bayesian module 22 are shown is arranged within this information portal IP. This search field 40 can be edited by the physician. A number of click boxes via which the user 8 can select the respective secondary data sources 20A, 20B are provided below the search field. As soon as the user 8 calls up the index card IP, the routine for automatic generation of the context-related criteria K as well as the search for the context-related secondary information SI is started. This is particularly appropriate when the case-related data have changed or a new case is present. For example, a change exists when new diagnosis images that should ultimately form a basis for the diagnosis are present in the patient-specific data.

The search for context-related secondary information SI ensues using the selected secondary data sources 20A, 20B. In the exemplary embodiment the selected secondary data sources are the PACS database, the reference database REF and the Internet NET. A separate region in which the individual matches are listed in a match list is provided for each data source. Detail information regarding the individual matches can be shown in the detail window 50 by clicking on the individual matches. In the exemplary embodiment this is an image from the reference database REF. Given matches on the Internet NET, a browser window of an Internet browser is advantageously started and the corresponding Internet page is opened via clicking on a corresponding match entry which is advantageously formed by a link.

An intuitive, user-friendly menu guidance that is entirely embedded within the conventional medical operation software is achieved via the user interface 41 shown in FIG. 3.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for assisting in generating a medical diagnosis for a medical case comprising:
providing a computerized processor with case-related primary information associated with said medical case;
in said computerized processor, automatically determining context-related criteria from said case-related primary information;
from said computerized processor, accessing a secondary data source and automatically filtering out context-related secondary information from said secondary data source using said context-related criteria; and
making said context-related secondary information accessible to a user via an information portal associated with said computerized processor.

2. A method as claimed in claim 1 comprising providing said computerized processor, as at least a portion of said case-related primary information, with patient information from an electronic patient record for a patient associated with said medical case.

3. A method as claimed in claim 1 comprising providing said computerized processor, as at least a portion of said case-related primary information, with diagnostic images associated with said medical case.

4. A method as claimed in claim 1 comprising determining said context-related criteria dependent on a current user of said computerized processor.

5. A method as claimed in claim 1 comprising determining said context-related criteria using Bayesian statistics.

6. A method as claimed in claim 1 comprising employing, as said context-related criteria, search terms designed to extract said context-related secondary information from said secondary data source.

7. A method as claimed in claim 6 comprising using a language module in said computerized processor to select search terms dependent on said primary information.

8. A method as claimed in claim 1 comprising automatically prioritizing said context-related secondary information and making said context-related secondary information available through said information portal in prioritized form.

9. A method as claimed in claim 1 comprising automatically generating, in said computerized processor, control commands for execution of an auxiliary program and executing said auxiliary program to automatically filter out said context-related secondary information from said secondary data source.

10. A method as claimed in claim 1 comprising allowing manual editing of the automatically determined context-related criteria.

11. A method as claimed in claim 1 wherein said secondary data source is a first secondary data source, and comprising also automatically filtering out said context-related secondary information from further secondary data sources in addition to said first secondary data source.

12. A method as claimed in claim 11 comprising selecting said first data source and said further secondary data sources from among data sources selected from the group consisting of access-protected internal data sources and public data sources.

13. A method as claimed in claim 11 comprising selecting said first data source and said further data sources from the group of data sources selected from the group consisting of diagnosis data for respectively different medical cases, standard medical reference data, internet-based data sources, internet-based data sources, and local data sources related to said computerized processor.

14. A method as claimed in claim 11 comprising allowing selection of a data source, from among said first secondary data source and said further secondary data sources, by a user of said computerized processor.

15. A method as claimed in claim 1 comprising integrating at least the step of making said context-related secondary information accessible to a user into an information platform of a user interface of superordinate medical operation software running on said computerized processor.

16. A method as claimed in claim 1 wherein the step of making said context-related secondary information accessible to a user comprises visually displaying a match list for said context-related secondary information in a result window of a display connected to said computerized processor, and allowing interaction by a user of said computerized processor with said match list to select an item in said match list for more detailed presentation at said display.

17. A method as claimed in claim 1 comprising retrieving current context-related secondary information and making said current context-related secondary information accessible, upon activation of said information portal.

18. A data processing system for assisting in generating a medical diagnosis for a medical case comprising:
a computerized processor provided with case-related primary information associated with said medical case;
said computerized processor automatically determining context-related criteria from said case-related primary information;
said computerized processor comprising an access portal allowing, from said computerized processor, access to a secondary data source and said computerized automatically filtering out context-related secondary information from said secondary data source using said context-related criteria; and
an information portal associated with said computerized processor that makes said context-related secondary information accessible to a user.

19. A computer-readable medium encoded with programming instructions for assisting in generating a medical diagnosis for a medical case, said medium being loadable into a computerized processor provided with case-related primary information associated with said medical case, and said programming instructions causing said computerized processor to:
automatically determine context-related criteria from said case-related primary information;
access a secondary data source and automatically filter out context-related secondary information from said secondary data source using said context-related criteria; and
make said context-related secondary information accessible to a user via an information portal associated with said computerized processor.
